(19) United States
(12) Patent Application Publication
(10) Pub. No.: US 2026/0021969 A1
(43) Pub. Date: Jan. 22, 2026

(54) CONTAINER HANDLING VEHICLE

(71) Applicant: AutoStore Technology AS, Nedre Vats (NO)

(72) Inventor: Tor Eirik Nordtveit Jensen, Haugesund (NO)

(21) Appl. No.: 18/875,692

(22) PCT Filed: Sep. 25, 2023
(86) PCT No.: PCT/EP2023/076366

§ 371 Date: Dec. 16, 2024

(30) Foreign Application Priority Data
Sep. 26, 2022 (NO) 20221018

(51) Int. Cl. B65G 1/137; B65G 1/04; B65G 1/06

(52) U.S. Cl. CPC B65G 1/1375; B65G 1/0464; B65G 1/065

(57) ABSTRACT

The present invention provides a container handling vehicle for moving in two perpendicular horizontal directions on a rail system, the rail system comprising a first set of parallel rails and a second set of parallel rails arranged perpendicular to the first set of parallel rails, the container handling vehicle comprising a vehicle frame; an internal storage space arranged in an upper portion of the vehicle frame; a lifting device comprising a lifting frame for releasably connecting to a storage container, the lifting frame featuring a centre opening through which an item arranged in the storage container may be retrieved, the lifting frame being vertically moveable between a lower position and an upper position; and a robotic item picker; wherein the robotic item picker is configured to transfer an item between the storage space and a storage container when the storage container is connected to the lifting frame and the lifting frame is in the upper position.

### FIELD OF THE INVENTION

The present invention relates to a container handling vehicle, a storage system comprising the container handling vehicle, and a method of retrieving storage containers in the storage system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a horizontal grid-based rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b, 301c,401b, 401c can be lifted and lowered, so that the first set of wheels 201b,301b,401b and/or the second set of wheels 201c, 301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 404d comprising container connectors 404b and guiding pins 404c adapted to engage a storage container 106. The lifting frame 404d can be lowered from the vehicle 201,301,401 so that the position of the lifting frame 404d with respect to the vehicle 201,301,401 can be adjusted in a third direction Z which is orthogonal the first direction Y and the second direction X. The lifting device of the container handling vehicle 201 is located within the vehicle body 201a in FIG. 2.

To raise or lower the lifting frame 404d (and optionally a connected storage container 106), the lifting frame 404d is suspended from a band drive assembly by lifting bands 404a. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The lateral area defined by a storage column is equal to the lateral area defined by a grid cell 122 of the rail system 108. The lateral area of a grid cell includes the area of the access opening 112 and half the width of the rails at the periphery of the access opening.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lift device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the 40 automated storage and retrieval system 1 comprises a control system 500 which typically is computerized and which typically comprises a database for keeping track of the storage containers 106.

The prior art storage system described above is often used to fulfil shipment orders to be sent to a customer. A shipment order will often comprise a plurality of different items commonly stored in separate storage containers. The container handling vehicles are used to retrieve the separate storage containers and deliver them to an access station at which the different items are picked and consolidated into a shipment order. Fulfilling a shipment order in this manner may in some cases be inefficient since the container handling vehicles may be required to transport a large number of storage containers back and forth to a port column connected to the access station.

In view of the above, it is desirable to provide a container-handling vehicle that may provide a more efficient method of fulfilling a shipment order, an automated storage and retrieval system comprising said container-handling vehicle, and a method for operating such a system.

### SUMMARY OF THE INVENTION

The present invention is defined in the attached claims and in the following:

In a first aspect, the present invention provides a container handling vehicle for moving in two perpendicular horizontal directions on a rail system, the rail system comprising a first set of parallel rails and a second set of parallel rails arranged perpendicular to the first set of rails, the container handling vehicle comprising
a vehicle frame;
an internal storage space arranged in an upper portion of the vehicle frame;
a lifting device comprising a lifting frame for releasably connecting to a storage container, the lifting frame featuring a centre opening through which an item arranged in the storage container may be retrieved, the lifting frame being vertically moveable between a lower position and an upper position; and
a robotic item picker;
wherein the robotic item picker is configured to transfer an item between the storage space and a storage container when the storage container is connected to the lifting frame and the lifting frame is in the upper position.

In an embodiment of the container handling vehicle, the robotic item picker may be configured to transfer an item in a horizontal direction between the storage space and the storage container. The internal storage space may be arranged horizontally adjacent to or to one side of the lifting frame, when the lifting frame is in the upper position. In other words, the robotic item picker may be configured to move horizontally between a position above the internal storage space and a position above the lifting frame. The internal storage space may be enclosed within the vehicle frame and comprises, and/or is accessible by the robotic item picker via, an access opening facing in a horizontal direction. The access opening may be adjacent to, or facing, the lifting frame when the lifting frame is in the upper position. At least a portion of the robotic item picker may move through the access opening when transferring an item between the storage space and a storage container when the storage container is connected to the lifting frame and the lifting frame is in the upper position.

In an embodiment of the container handling vehicle, the robotic item picker is configured to move above and/or within the storage space and the lifting frame when the lifting frame is in the upper position. That is, the robotic item picker is configured to move at a level above an upper level of the lifting frame arranged in the upper position.

In an embodiment of the container handling vehicle, the robotic item picker is moveably connected to a rail assembly configured to allow the robotic item picker to move in two perpendicular horizontal directions. The rail assembly (may also be termed a beam assembly) may comprise two stationary and parallel first rails extending horizontally above the lifting frame and the internal storage space, and a second rail (or beam) being perpendicular to the first rails. The second rail may be moveably connected to the first rails and may move in a horizontal direction parallel to the first rails. The robotic item picker may be connected to the second rail. In an embodiment, the robotic item picker may be moveably connected to the second rail to move in a direction parallel to the first rail.

In an embodiment of the container handling vehicle, the robotic item picker may comprise an item interaction device being moveable in a vertical direction, e.g. in a vertical direction relative to the vehicle frame or the rail assembly. The item interaction device may lift an item by use of any suitable effector, such as a mechanical robotic gripper or a vacuum/suction gripper.

In an embodiment, the container handling vehicle may comprise at least one optical sensor, the sensor may identify an item to be picked and optionally decide the best way the robotic item picker may pick the item. The optical sensor may be an RGB-D camera. The optical sensor may be arranged on, or configured to move together with, the robotic picker.

In an embodiment, the container handling vehicle may comprise two optical sensors, a first sensor arranged at the internal storage space and a second sensor arranged above or on the lifting frame. The first sensor may identify an item to be picked from the internal storage space and optionally decide the best way the robotic item picker may pick the item. The second sensor may identify an item to be picked from a storage container connected to the lifting frame and optionally decide the best way the robotic item picker may pick the item.

In an embodiment of the container handling vehicle, the lifting frame may be adjacent to, or arranged sideways of, the storage space when the lifting frame is in the upper position.

In an embodiment, the container handling vehicle may comprise at least one lifting shaft, and the lifting frame is suspended from the at least one lifting shaft by lifting bands that may be spooled on or off the lifting shaft to raise or lower the lifting frame relative to the vehicle frame.

In an embodiment, the container handling vehicle may comprise a wheel assembly configured for moving the vehicle along any of the first set of parallel rails and the second set of parallel rails, the wheel assembly comprising at least four wheels.

The at least four wheels may be pivotable around a vertical axis to allow movement along any of the first set of parallel rails and the second set of parallel rails, or may be part of a first set of wheels arranged to engage with the first set of rails, and a second set of wheels arranged to engage with the second set of rails, wherein at least one of the sets of wheels can be lifted and lowered, so that the first set of wheels and/or the second set of wheels can be engaged with the respective set of rails at any one time.

In a second aspect, the present invention provides a storage system comprising a container handling vehicle according to any embodiment of the first aspect, the storage system comprising a framework structure providing a plurality of storage columns for accommodating a vertical stack of storage containers, and a rail system upon which the vehicle may move in two perpendicular directions above the storage columns. The framework structure may further comprise at least one port column at which the container handling vehicle may transfer a storage container between the rail system to an access station.

In an embodiment of the storage system, the lifting frame may be configured to releasably connect to an upper storage container of a stack of storage containers when the lifting frame is in the lower position.

In an embodiment of the storage system, the rail system comprises a first set of parallel rails and a second set of parallel rails arranged perpendicular to the first set of rails, providing a horizontal grid-based rail system defining a plurality of grid cells, a grid cell arranged at each upper end of the storage columns and the port column. A grid cell may be defined as the cross-sectional area between the vertical centre planes of opposed rails running in the X direction and opposed rails running in the Y direction. A grid cell opening may be defined as the open cross-sectional area between two opposed rails running in the X direction and two opposed rails running in the Y direction.

In an embodiment, the storage system comprises a plurality of upright members and each storage column is defined by four of the upright members.

In an embodiment of the storage system, the rail system is arranged on top of the upright members.

In a third aspect, the present invention provides a method of retrieving an item from a storage container in a storage system according to any embodiment of the second aspect, the method comprising the steps of:
moving the container handling vehicle to arrange the lifting frame above a storage column accommodating the storage container;
lowering the lifting frame into the storage column;
connecting the lifting frame to the storage container;
raising the lifting frame to the upper position;
moving the robotic item picker to retrieve the item from the storage container; and
optionally moving the robotic item picker to deposit the item in the internal storage space.

In a fourth aspect, the present invention provides a method of consolidating items from storage containers in a storage system according to any embodiment of the second aspect, the method comprising the steps of:
moving the container handling vehicle to arrange the lifting frame above a storage column accommodating a first storage container accommodating a first item;
lowering the lifting frame into the storage column;
connecting the lifting frame to the first storage container;
raising the lifting frame to the upper position;
moving the robotic item picker to retrieve the first item from the first storage container;
moving the robotic item picker to deposit the first item in the internal storage space;
lowering the lifting frame into a storage column;
releasing the first storage container to store the first storage container in the storage column;
raising the lifting frame to the upper position;
moving the container handling vehicle to arrange the lifting frame above a storage column accommodating a second storage container accommodating a second item;
lowering the lifting frame into the storage column;
connecting the lifting frame to the second storage container;
raising the lifting frame to the upper position;
moving the robotic item picker to retrieve the second item from the second storage container;
optionally moving the robotic item picker to deposit the second item in the internal storage space;
lowering the lifting frame into a storage column;
releasing the second storage container to store the second storage container in the storage column;
raising the lifting frame to the upper position;
moving the container handling vehicle to arrange the lifting frame above a storage column accommodating a third storage container;
lowering the lifting frame into the storage column;
connecting the lifting frame to the third storage container;
raising the lifting frame to the upper position; and
operating the robotic item picker to retrieve the first item and optionally the second item from the internal storage space and consolidate the first and the second item in the third storage container, i.e. the robotic picker is operated to deposit both the first item and the second item in the third storage container.

In an embodiment, the method according to the fourth aspect may comprise the steps of:
moving the container handling vehicle to a port;
lowering the lifting frame to release the third storage container, containing the first item and the second item, for transfer to an access station.

In a fifth aspect, the present invention provides a method of consolidating items from storage containers in a storage system according to any embodiment of the second aspect, the method comprising the steps of:
moving the container handling vehicle to arrange the lifting frame above a storage column accommodating a first storage container accommodating a first item;
lowering the lifting frame into the storage column;
connecting the lifting frame to the first storage container;
raising the lifting frame to the upper position;
moving the robotic item picker to retrieve the first item from the first storage container;
optionally moving the robotic item picker to deposit the first item in the internal storage space;
lowering the lifting frame into a storage column;
releasing and the first storage container to store the first storage container in the storage column;
raising the lifting frame to the upper position;
moving the container handling vehicle to arrange the lifting frame above a storage column accommodating a second storage container accommodating a second item;
lowering the lifting frame into the storage column;
connecting the lifting frame to the second storage container;
raising the lifting frame to the upper position;
optionally moving the robotic item picker to retrieve the first item from the internal storage space; and
moving the robotic item picker to deposit the first item in the second storage container to consolidate the first item and the second item.

### BRIEF DESCRIPTION OF THE DRAWINGS

Embodiments of the present invention are described in detail by way of example only and with reference to the following drawings:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a side view of a first exemplary container handling vehicle according to the invention.

FIG. 6 is a side view of the container handling vehicle in FIG. 5 retrieving a storage container.

FIG. 7a is a side view of the container handling vehicle in FIG. 6, wherein the storage container is in an upper position.

FIG. 7b is a top view of the container handling vehicle in FIG. 7a.

FIG. 8a is a side view of the container handling vehicle in FIG. 7a, wherein a robotic picker is arranged above a storage space.

FIG. 8b is a top view of the container handling vehicle in FIG. 8a.

FIG. 9a is a side view of a second exemplary container handling vehicle according to the invention.

FIG. 9b is a top view of the container handling vehicle in FIG. 9a.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

As mentioned above, in some cases it would be advantageous to be able to consolidate the items of a shipping order without requiring a container handling vehicle to retrieve and transport a plurality of storage container between a storage column and a port column. The present disclosure provides a container handling vehicle by which vehicle a plurality of items may be consolidated in a common storage container and subsequently transported to a port column for delivery to an access station.

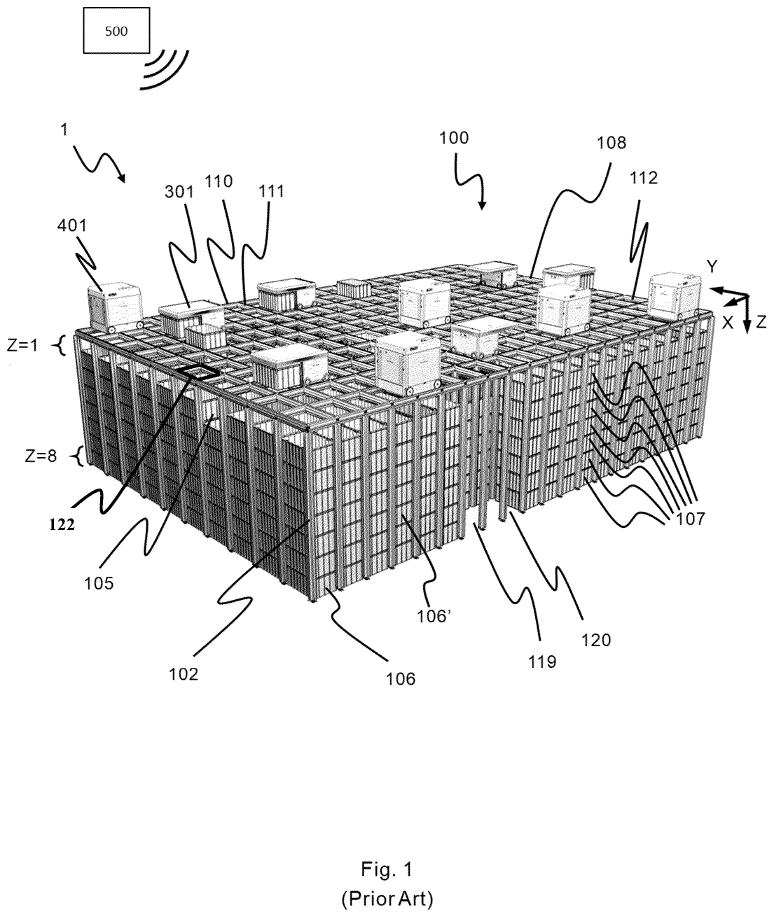

The container handling vehicle according to the invention is intended for use in automated storage and retrieval systems, also termed a container handling system, having a framework structure 100 as described above in connection with FIGS. 1-3. The framework structure 100 comprises a plurality of upright members 102 (i.e. vertical column profiles) and a rail system 108 forming a rail grid extending in the first direction X and the second direction Y. The rail system 108 features a first set of parallel rails 110 in the first direction and a second set of parallel rails 111 in the second direction. The upright members 102 define storage columns 105 in which storage containers 106 may be stacked on top of each other. The storage containers of the automated storage and retrieval system may be configured to fulfil various functions, such as storage of items and goods and growth modules for plants. In the latter case, the automated storage and retrieval system may also be termed a vertical farming system.

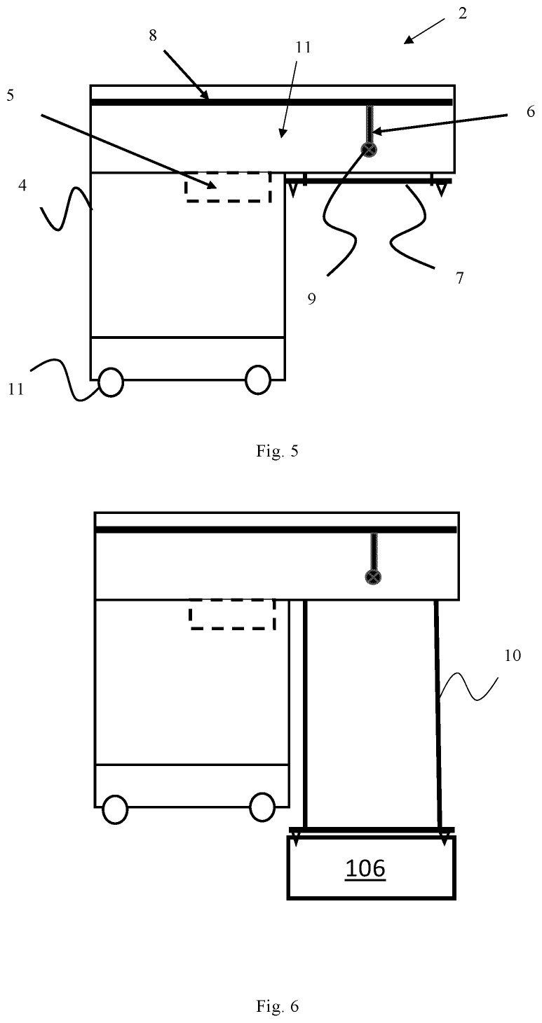

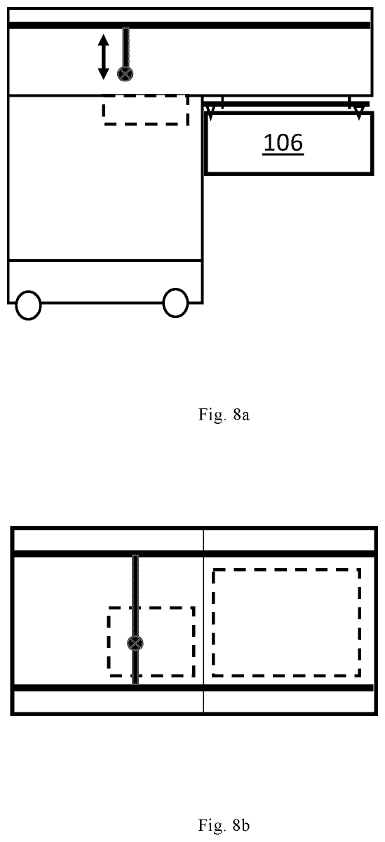

A first exemplary embodiment of a container handling vehicle 2 according to the invention is shown in FIGS. 5-8.

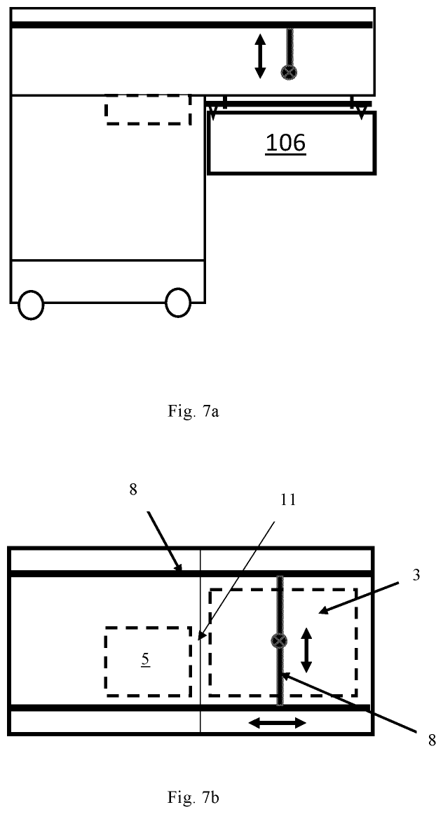

The vehicle features a vehicle frame 4, an internal storage space 5 arranged in an upper portion of the vehicle frame 4, a robotic item picker 6 and a lifting device for retrieving storage containers from, or storing storage containers in, a storage column 105 of a container storage system. The lifting device features a vertically moveable lifting frame 7 for releasably connecting to a storage container 106, see FIG. 10. The lifting frame may have the same features as the lifting frame of the prior art vehicles 201,301,401, in addition to a centre opening 3. The centre opening 3 allows top access to a connected storage container 106, see FIG. 10. The lifting frame 7 is suspended from at least one lifting shaft by lifting bands 12 and is vertically moveable between a lower position and an upper position relative to the vehicle frame 4, see FIGS. 6 and 7a. The vehicle frame 4 of the first exemplary embodiment is similar to the vehicle frame of the prior art vehicle shown in FIG. 3, i.e. comprising a cantilever section from which the lifting frame 7 is suspended.

The internal storage space 5 may be enclosed within the vehicle frame 4 and comprises, and/or is accessible by the robotic item picker via, an access opening 11 facing in a horizontal direction. The access opening 11 is arranged in the direction of the lifting frame when the lifting frame is in the upper position.

The robotic item picker 6 is arranged in the upper portion of the vehicle frame at a level above both the internal storage space 5, i.e. above a support surface or floor of the internal storage space, and the lifting frame. The robotic item picker 6 is configured to transfer an item between the storage space 5 and a storage container 106 when the storage container 106 is connected to the lifting frame 7 and the lifting frame 7 is in the upper position. In the upper position the lifting frame 7 is preferably adjacent to the internal storage space 5 to provide a minimum travel distance for the robotic picker 6 between the internal storage space 5 and the storage container 106.

The robotic item picker 6 is moveably connected to a rail/beam assembly 8. The rail/beam assembly may extend over both the internal storage space 5 and the lifting frame 7, such that the robotic item picker 6 can move in two perpendicular horizontal directions above or within the internal storage space 5 and above the lifting frame 7. The robotic item picker 6 comprises an item interaction device 9 being moveable in a vertical direction. In alternative embodiments, the robotic item picker may e.g. comprise a robotic arm arranged between the internal storage space and the lifting frame, the robotic arm configured to move the robotic item picker in the required vertical and horizontal directions. The item interaction device 9 is an effector, e.g. a mechanical finger gripper or a vacuum/suction gripper, that may lift and release an item. The robotic picker may feature at least one optical sensor, e.g. an RGB-D camera. The optical sensor may identify an item to be picked, as well as decide the best way the robotic item picker may pick the item.

A simple item picking method that may be performed by the first exemplary container handling vehicle when used in a storage system as described above is illustrated in FIGS. 6-8b.

The method may comprise the steps of:
moving the container handling vehicle 2 to arrange the lifting frame above a storage column 105 accommodating a storage container 106 containing the item to be picked;
lowering the lifting frame 7 into the storage column 105;
connecting the lifting frame 7 to the storage container 106;
raising the lifting frame 7 to the upper position;
moving the robotic item picker 6 vertically and horizontally to retrieve the item from the storage container; and
moving the robotic item picker 6 horizontally from a position above the storage container to a position above or within the internal storage space 5; and
depositing the item in the internal storage space.

When the item has been retrieved by the robotic item picker 6, the storage container 106 may be returned to the storage column 105. Additional items from other storage containers 106 may subsequently be temporarily stored in the internal storage space 5 before being consolidated in a common storage container, e.g. for delivery to an access station.

When a first item from a first storage container and a second item from a second storage container is to be consolidated in the second storage container, the robotic picker may hold the first item while the container handling vehicle retrieves the second storage container, i.e. the first item is not temporarily deposited in the internal storage space, and subsequently deposit the first item in the second storage container.

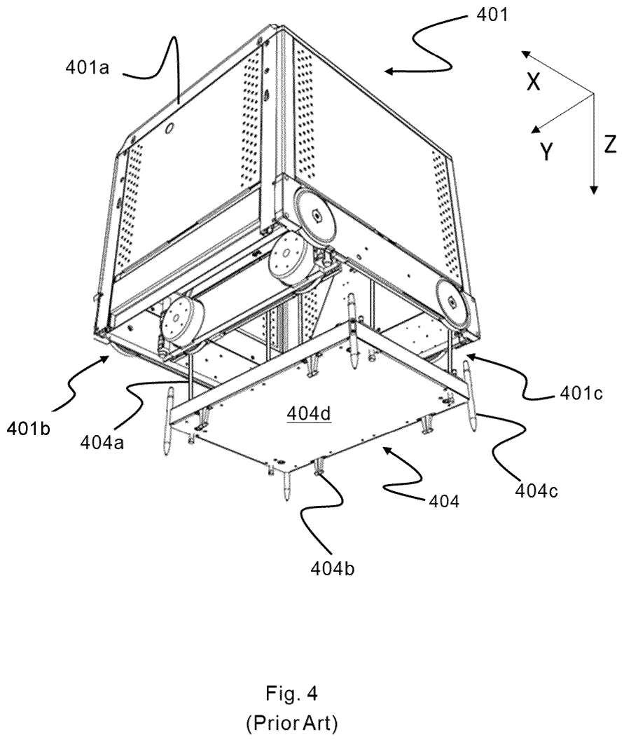

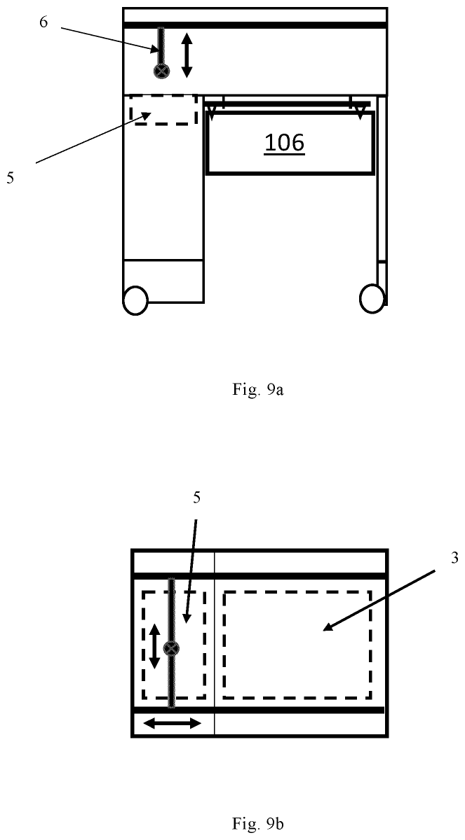

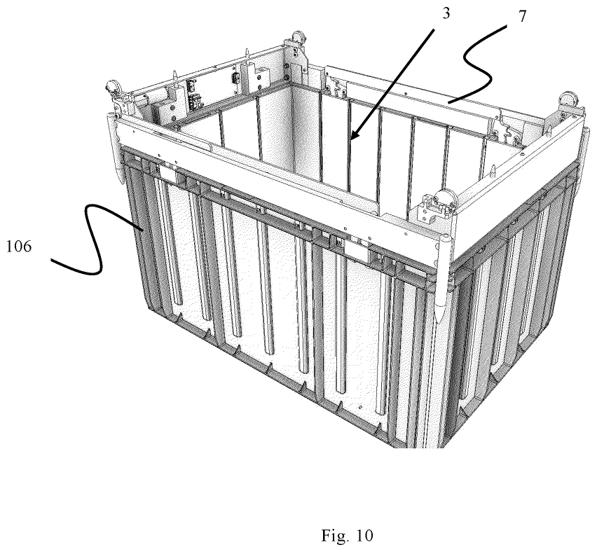

A second exemplary container handling vehicle 2′ is shown in FIGS. 9a and 9b. The vehicle frame 4 of the second exemplary embodiment is similar to the vehicle frame of the prior art vehicle shown in FIG. 4, i.e. comprising a cavity into which the lifting frame 7 and a connected storage container 106 may be lifted. The configuration and functionality of the robotic item picker 6 are as described for the first exemplary embodiment above.

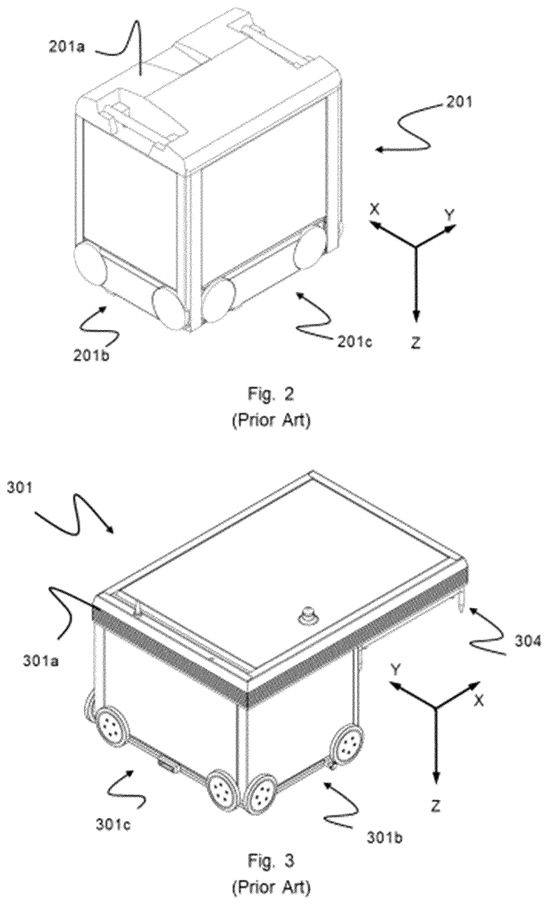

Each of the illustrated container handling vehicles 2 features a wheel assembly configured for moving the vehicle 2 along any of the first set of parallel rails 110 and the second set of parallel rails 111. The wheel assembly is similar to the wheel assemblies of the prior art vehicles in FIGS. 2-4. In other words, the inventive vehicle may have a first set of wheels and a second set of wheels, as described above in connection with the prior art vehicles 201,301,401 and in for instance WO2015/193278 A1 and WO2017/153583. The first set of wheels may be arranged to engage with two parallel rails of the first set of rails 110, and the second set of wheels may be arranged to engage with two parallel rails of the second set of rails 111. At least one of the sets of wheels can be lifted and lowered, so that the first set of wheels and/or the second set of wheels can be engaged with the respective set of rails 110, 111 at any one time.

The container handling vehicle 2,2′ features an electronic control module, for wireless communication with a control system 500 of an automated storage system as described above, and a rechargeable battery. The robotic item picker may be connected to the control system 500 via the electronic control module.

The container handling vehicle according to the invention may increase the efficiency of consolidation operations performed in an automated storage system as described above. The vehicle 2,2′ may also be used to transport a storage container in which a shipment order is consolidated to a port area at which the storage container may be transferred between the framework structure and an access station.

### LIST OF REFERENCE NUMBERS

1 Prior art automated storage and retrieval system
2.2′ Container handling vehicle according to the invention
3 Centre opening of lifting frame
4 Vehicle frame
5 Internal storage space
6 Robotic item picker
7 Lifting frame
8 Rail/beam assembly
9 Item interaction device
10 Lifting bands
11 Access opening to internal storage space
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
First direction
Y Second direction
Z Third direction

1. A container handling vehicle for moving in two perpendicular horizontal directions on a rail system, the rail system comprising a first set of parallel rails and a second set of parallel rails arranged perpendicular to the first set of parallel rails, the container handling vehicle comprising:
a vehicle frame;
an internal storage space arranged in an upper portion of the vehicle frame;
a lifting device comprising a lifting frame for releasably connecting to a storage container, the lifting frame featuring a centre opening through which an item arranged in the storage container is retrieved, the lifting frame being vertically moveable between a lower position and an upper position; and
a robotic item picker;
wherein the robotic item picker is configured to transfer the item between the internal storage space and the storage container when the storage container is connected to the lifting frame and the lifting frame is in the upper position.

2. The container handling vehicle according to claim 1, wherein the robotic item picker is configured to move above the internal storage space and the lifting frame when the lifting frame is in the upper position.

3. The container handling vehicle according to claim 1, wherein the robotic item picker is moveably connected to a rail or beam assembly configured to allow the robotic item picker to move in the two perpendicular horizontal directions.

4. The container handling vehicle according to claim 1, wherein the robotic item picker comprises an item interaction device being moveable in a vertical direction.

5. The container handling vehicle according to claim 1, wherein the lifting frame is adjacent to the internal storage space when the lifting frame is in the upper position.

6. The container handling vehicle according to claim 5, further comprising at least one lifting shaft, wherein the lifting frame is suspended from the at least one lifting shaft by lifting bands that are spooled on or off the at least one lifting shaft to raise or lower the lifting frame relative to the vehicle frame.

7. The container handling vehicle according to claim 1, further comprising a wheel assembly configured for moving the container handling vehicle along any of the first set of parallel rails and the second set of parallel rails, the wheel assembly comprising at least four wheels.

8. A storage system comprising a container handling vehicle according to claim 1, the storage system comprising a framework structure providing a plurality of storage columns for accommodating a vertical stack of storage containers, and a rail system upon which the container handling vehicle may move in two perpendicular directions above the plurality of storage columns.

9. The storage system according to claim 8, wherein the lifting frame is configured to releasably connect to an upper storage container of a stack of storage containers when the lifting frame is in the lower position.

10. A method of retrieving an item from a storage container in a storage system according to claim 8, the method comprising:
moving the container handling vehicle to arrange the lifting frame above a storage column accommodating the storage container;
lowering the lifting frame into the storage column;
connecting the lifting frame to the storage container;
raising the lifting frame to the upper position; and
moving the robotic item picker to retrieve the item from the storage container.

11. The method according to claim 10, further comprising:
moving the robotic item picker to deposit the item in the internal storage space.

12. The method according to claim 11, wherein the method is configured to consolidate items from storage containers in the storage system, the method further comprising:
lowering the lifting frame into a storage column;
releasing the storage container to store the storage container in the storage column;
raising the lifting frame to the upper position;
moving the container handling vehicle to arrange the lifting frame above a storage column accommodating a second storage container accommodating a second item;
lowering the lifting frame into the storage column;
connecting the lifting frame to the second storage container;
raising the lifting frame to the upper position;
moving the robotic item picker to retrieve the second item from the second storage container;
optionally moving the robotic item picker to deposit the second item in the internal storage space;
lowering the lifting frame into a storage column;
releasing the second storage container to store the second storage container in the storage column;
raising the lifting frame to the upper position;
moving the container handling vehicle to arrange the lifting frame above a storage column accommodating a third storage container;
lowering the lifting frame into the storage column;
connecting the lifting frame to the third storage container;
raising the lifting frame to the upper position; and
operating the robotic item picker to retrieve the item and optionally the second item from the internal storage space and consolidate the item and the second item in the third storage container.

13. The method according to claim 12, further comprising:
moving the container handling vehicle to a port; and
lowering the lifting frame to release the third storage container for transfer to an access station.

14. The method according to claim 10, wherein the method is configured to consolidate items from storage containers in the storage system, the method further comprising:
optionally moving the robotic item picker to deposit the item in the internal storage space;
lowering the lifting frame into a storage column;
releasing the storage container to store the storage container in the storage column;
raising the lifting frame to the upper position;
moving the container handling vehicle to arrange the lifting frame above a storage column accommodating a second storage container accommodating a second item;
lowering the lifting frame into the storage column;
connecting the lifting frame to the second storage container;
raising the lifting frame to the upper position;
optionally moving the robotic item picker to retrieve the item from the internal storage space; and
moving the robotic item picker to deposit the item in the second storage container to consolidate the item and the second item.
